(19) United States
(12) Patent Application Publication
(10) Pub. No.: US 2026/0321956 A1
(43) Pub. Date: Oct. 15, 2026

(54) ANTENNA CONTROL METHOD AND COMMUNICATION APPARATUS

(71) Applicant: HUAWEI TECHNOLOGIES CO., LTD., Shenzhen (CN)

(72) Inventors: Hongjing Xu, Shanghai (CN); Xianghua Li, Shenzhen (CN); Ni Ma, Shanghai (CN); Guanxi Zhang, Shanghai (CN)

(21) Appl. No.: 19/690,119

(22) Filed: May 28, 2026

Related U.S. Application Data
(63) Continuation of application No. PCT/CN2024/121320, filed on Sep. 26, 2024.

(30) Foreign Application Priority Data
Nov. 30, 2023 (CN) 202311640629.8

(51) Int. Cl. H01Q 1/08; H01Q 1/10; H01Q 1/24; H01Q 1/36; H01Q 1/50

(52) U.S. Cl. CPC H01Q 1/084; H01Q 1/10; H01Q 1/241; H01Q 1/36; H01Q 1/50

(57) ABSTRACT

Embodiments provide an antenna control method and apparatus and system for executing the method. The method is executed by a communication apparatus including a main antenna panel in a deployed configuration and at least one auxiliary antenna panel. The method includes obtaining wind speed information. Determining, based on the wind speed information, whether to adjust a configuration of the auxiliary antenna panel. The configuration of the auxiliary antenna panel includes one of a deployed configuration and a stowed configuration. An antenna panel is in the deployed configuration for the antenna panel performing signal transmission. The antenna panel includes the main antenna panel and the auxiliary antenna panel. The method further includes adjusting the configuration of the auxiliary antenna panel in response to determining to adjust the configuration of the auxiliary antenna panel.

### CROSS-REFERENCE TO RELATED APPLICATIONS

This application is a continuation of International Application No. PCT/CN2024/121320, filed on Sep. 26, 2024, which claims priority to Chinese Patent Application No. 202311640629.8, filed on Nov. 30, 2023. The disclosures of the aforementioned applications are hereby incorporated by reference in their entireties.

### TECHNICAL FIELD

This disclosure relates to the field of communication technologies, and in particular, to an antenna control method and a communication apparatus.

### BACKGROUND

An antenna panel is configured to send and receive a signal, and is an important component of a communication apparatus (for example, a base station). Currently, to prevent, at various wind speeds, an antenna from being damaged, a size of the antenna panel is required to satisfy a wind resistance requirement of force-14 wind. Due to the size limitation of the antenna panel, a communication capacity and resolution cannot be further improved, and many practical requirements cannot be satisfied. For example, the base station is required to achieve vertical big-angle coverage (60° to 75°) in a communication scenario of an unmanned aerial vehicle, but the existing antenna can only implement a scanning range of ±13°; and horizontal resolution of the existing antenna lags by a factor of three behind the width of 3.5-4 m of lanes required to be distinguished by a base station antenna in a road sensing scenario. Therefore, how to improve a communication capacity and resolution while satisfying the requirement of wind resistance on the antenna is an urgent problem to be resolved currently.

### SUMMARY

This disclosure provides an antenna control method and a communication apparatus, to resolve a problem of a limited communication capacity and limited resolution caused by a fixed size of an antenna panel.

According to a first aspect, an antenna control method is provided. The method may be applied to a communication apparatus. The communication apparatus includes a main antenna panel and at least one auxiliary antenna panel. The main antenna panel is in a deployed configuration.

The method includes: obtaining wind speed information; determining, based on the wind speed information, whether to adjust a configuration of the auxiliary antenna panel; and adjusting the configuration of the auxiliary antenna panel in response to determining to adjust the configuration of the auxiliary antenna panel. The configuration of the auxiliary antenna panel includes a deployed configuration and a stowed configuration. An antenna panel is in the deployed configuration when the antenna panel performs signal transmission. The antenna panel includes the main antenna panel and the auxiliary antenna panel.

For example, the communication apparatus may further include a sensor. The sensor is configured to obtain wind speed information. For example, the sensor may be arranged on the main antenna panel and/or a part or all of the at least one auxiliary antenna panel.

A current size of the antenna panel is required to satisfy a wind resistance requirement of force-14 wind. However, force-14 wind occurs only once in several decades, and the wind speed is below a force 4 for most of the time. The communication apparatus can support an antenna panel of a larger size (or area) during most periods. According to the antenna control method provided in this disclosure, the configuration of the auxiliary antenna panel may be flexibly adjusted based on the wind speed information, to increase a size of the antenna panel as much as possible while satisfying a requirement of wind resistance on the size of the antenna panel, further improve a communication capacity and resolution, expand a scanning range as much as possible in an integrated sensing and communication scenario, and improve sensing performance.

In some embodiments, the method further includes: obtaining service information. The determining, based on the wind speed information, whether to adjust the configuration of the auxiliary antenna panel includes: determining, based on the wind speed information and the service information, whether to adjust the configuration of the auxiliary antenna panel.

For example, the service information may be one or more of the following: a quantity of terminals connected to the communication apparatus, a current throughput of the communication apparatus, or a current data transmission rate.

Based on the solution, the configuration of the auxiliary antenna panel is adjusted based on the wind speed information and the service information, so that the size of the antenna panel can be increased as much as possible while the current requirement on the wind speed information and the service information is satisfied. This improves a communication capacity and resolution, expands the scanning range as much as possible in the integrated sensing and communication scenario, and improves sensing performance. For example, when the wind speed is relatively low, one or more auxiliary antenna panels may be properly deployed while the service requirement is satisfied, to increase the size of the antenna panel, and improve channel capacity and resolution.

In some embodiments, the main antenna panel is movably connected to the auxiliary antenna panel. The adjusting the configuration of the auxiliary antenna panel includes: adjusting an angle between the auxiliary antenna panel and the main antenna panel.

Based on the solution, the configuration of the auxiliary antenna panel is adjusted by adjusting the angle (for example, an included angle) between the main antenna panel and the auxiliary antenna panel, to implement the adjustment of the size (an equivalent size) of the antenna panel.

In some embodiments, the auxiliary antenna panel is connected to the main antenna panel through a component that supports 360-degree free movement.

In some embodiments, the auxiliary antenna panel includes a first sub-antenna panel and a second sub-antenna panel, the first sub-antenna panel is movably connected to the main antenna panel, and the second sub-antenna panel is movably connected to the first sub-antenna panel.

Based on the solution, the auxiliary antenna panel may include a plurality of sub-antenna panels, and the sub-antenna panels are movably connected, so that the size of the antenna panel can be adjusted more flexibly.

In some embodiments, the second sub-antenna panel is connected to the first sub-antenna panel through a component that supports a 360-degree or 180-degree free movement.

In some embodiments, the main antenna panel is connected to the auxiliary antenna panel through a telescopic component. The adjusting the configuration of the auxiliary antenna panel includes: adjusting a telescopic length of the auxiliary antenna panel relative to the main antenna panel.

Based on the solution, the configuration of the auxiliary antenna panel may be adjusted by adjusting the telescopic length of the auxiliary antenna panel relative to the main antenna panel, to implement the adjustment of the size of the antenna panel.

In some embodiments, the auxiliary antenna panel includes the first sub-antenna panel and the second sub-antenna panel. The first sub-antenna panel is connected to the main antenna panel through the telescopic component, and the second sub-antenna panel is connected to the first sub-antenna panel through the telescopic component.

Based on the solution, the auxiliary antenna panel may include a plurality of sub-antenna panels, and the sub-antenna panels are connected through the telescopic component, so that the size of the antenna panel can be adjusted more flexibly.

According to a second aspect, a communication apparatus is provided, including a module or a unit for performing the method according to the first aspect or any one of the embodiments in the first aspect.

According to a third aspect, a communication apparatus is provided, including a processor. When the processor executes a computer program (which may also be referred to as code or instructions) or instructions stored in a memory, the apparatus is enabled to perform the method according to the first aspect or any one of the embodiments in the first aspect.

In some embodiments, the apparatus further includes the memory.

In some embodiments, one or more processors are arranged, and/or one or more memories are arranged.

In some embodiments, the memory may be integrated with the processor, or the memory is arranged separately from the processor.

In some embodiments, the apparatus further includes a communication interface, and the processor is coupled to the communication interface.

For example, the communication interface may be a transceiver or an input/output interface.

According to a fourth aspect, a processor is provided, including an input circuit, an output circuit, and a processing circuit. The processing circuit is configured to receive a signal through the input circuit, and transmit the signal through the output circuit, to enable the processor to perform the method according to the first aspect or any one of the embodiments in the first aspect.

During implementation, the foregoing processor may be a chip, the input circuit may be an input pin, the output circuit may be an output pin, and the processing circuit may be a transistor, a gate circuit, a trigger, various logic circuits, and the like. An input signal received by the input circuit may be for example without limitation received and input by a receiver, a signal output by the output circuit may be for example without limitation output to and transmitted by a transmitter, and the input circuit and the output circuit may be a same circuit. The circuit is used as the input circuit and the output circuit at different moments. Implementations of the processor and various circuits are not limited in various embodiments.

According to a fifth aspect, an antenna is provided. The antenna includes the main antenna panel and the at least one auxiliary antenna panel described in the first aspect or any one of the embodiments of the first aspect. For details about the main antenna panel and the at least one auxiliary antenna panel, refer to the descriptions in the first aspect or any one of the embodiments of the first aspect. Details are not described herein again. For example, the antenna may further include a sensor. The sensor is configured to collect wind speed information.

According to a sixth aspect, a computer program product is provided. The computer program product includes a computer program. When the computer program is run, a computer is enabled to perform the method according to the first aspect or any one of the embodiments in the first aspect.

According to a seventh aspect, a non-transitory computer-readable storage medium is provided. The non-transitory computer-readable storage medium stores a computer program (which may also be referred to as code or instructions). When the computer program is run on a computer, the computer is enabled to perform the method according to the first aspect or any one of the embodiments in the first aspect.

According to an eighth aspect, a chip is provided, including a processor. The processor is configured to invoke a computer program from a memory, and run the computer program, to enable a communication apparatus equipped with the chip to perform the method according to the first aspect or any one of the embodiments in the first aspect.

According to a ninth aspect, a communication apparatus is provided. The communication apparatus includes an interface and a processor. The interface is configured to send and/or receive a signal, to enable the processor to perform the method according to the first aspect or any one of the embodiments in the first aspect.

### BRIEF DESCRIPTION OF DRAWINGS

FIG. 1 is a diagram of a communication apparatus according to an embodiment;

FIG. 2(a) to FIG. 2(h) are diagrams of relative position relationships between an auxiliary antenna panel and a main antenna panel when the auxiliary antenna panel is in a deployed configuration and in a stowed configuration according to an embodiment;

FIG. 3(a) to FIG. 3(d) are diagrams of possible forms of an antenna panel of a communication apparatus according to an embodiment;

FIG. 4 is a diagram of a connection relationship between an auxiliary antenna panel and a main antenna panel according to an embodiment;

FIG. 5 is a diagram of a possible structure of an auxiliary antenna panel according to an embodiment;

FIG. 6 is a diagram of connection relationships between sub-antenna panels and between a sub-antenna panel and a main antenna panel according to an embodiment;

FIG. 7 is a schematic flowchart of an antenna control method according to an embodiment;

FIG. 8(a) to FIG. 8(d) are diagrams of correspondences between a wind speed force and an antenna panel configuration according to an embodiment;

FIG. 9(a) to FIG. 9(c) are diagrams of correspondences between a wind speed force and an antenna panel configuration according to an embodiment;

FIG. 10(a) to FIG. 10(c) are diagrams of correspondences between a wind speed force and an antenna panel configuration according to an embodiment;

FIG. 11 is a diagram of a structure of a network device according to an embodiment;

FIG. 12 is a diagram of a structure of another network device according to an embodiment;

FIG. 13 is a block diagram of a communication apparatus according to an embodiment; and

FIG. 14 is a block diagram of another communication apparatus according to an embodiment.

### DESCRIPTION OF EMBODIMENTS

Technical solutions in embodiments of this disclosure are described below with reference to the accompanying drawings in embodiments.

In the descriptions of this disclosure, unless otherwise specified, “/” indicates an “or” relationship between associated objects. For example, A/B may represent A or B. The term “and/or” in this specification describes only an association relationship between associated objects, and represents that three relationships may exist. For example, A and/or B may represent the following three cases: only A exists, both A and B exist, and only B exists, where A and B may be singular or plural. In addition, in the descriptions of this disclosure, unless otherwise specified, “a plurality of” means two or more than two. “At least one of the following items (pieces) or a similar expression thereof” refers to any combination of these items, including any combination of singular items (pieces) or plural items (pieces). For example, at least one item (piece) of a, b, or c may represent a, b, c, a-b, a-c, b-c, or a-b-c, where a, b, and c may be singular or plural. In addition, to clearly describe the technical solutions in embodiments of this disclosure, words such as “first” and “second” are used in embodiments to distinguish between same items or similar items whose functions and effects are substantially the same. A person skilled in the art may understand that the terms such as “first” and “second” do not limit a quantity and an execution order, and the terms such as “first” and “second” are not limited to be unnecessarily different.

In the method embodiments, a magnitude of a sequence number does not mean the order of execution, and the order of execution should be determined by functions and internal logic, and should not constitute any limitation on the process of the embodiments.

It may be understood that, in this disclosure, descriptions similar to “in a case that”, “if”, “when”, “provided that ...” , and the like may be used interchangeably. In addition, these descriptions all mean that corresponding processing is to be performed in an objective condition, and are not intended to limit time, and are not required to perform a determining action during implementation, and do not mean that another limitation exists.

It may be understood that in this disclosure, “greater than or equal to” may be replaced with “greater than”, and correspondingly, “less than” may also be replaced with “less than or equal to”.

It may be understood that, in some scenarios, some optional features in embodiments of this disclosure may be independently implemented without depending on another feature, for example, a solution on which the optional features are currently based, to resolve a corresponding technical problem and achieve a corresponding effect. Alternatively, in some scenarios, the optional features may be combined with another feature as required. Correspondingly, the apparatus provided in embodiments of this disclosure may also correspondingly implement these features or functions. Details are not described herein.

In this disclosure, unless otherwise specified, for same or similar parts in embodiments, refer to each other. In embodiments of this disclosure and the implementations/implementation methods/implementing methods in embodiments, unless otherwise specified or in logical conflicts, terms and/or descriptions between different embodiments and implementations/implementation methods/implementing methods in embodiments have consistency and may be mutually referenced. Technical features in different embodiments and implementations/implementation methods/implementing methods in embodiments may be combined according to internal logical relationships thereof to form a new embodiment, implementation, or implementation method. The following implementations of this disclosure do not constitute a limitation on the protection scope of this disclosure.

A terminal in embodiments of this disclosure is also referred to as user equipment (UE), a terminal device, a mobile station (MS), a mobile terminal (MT), or the like, and is a device that provides voice and/or data connectivity for a user. For example, the terminal may be a mobile phone, a tablet computer, a notebook computer, a palmtop computer, a mobile internet device (MID), a wearable device, a virtual reality (VR) device, an augmented reality (AR) device, a wireless terminal in industrial control, a wireless terminal in self-driving, a wireless terminal in remote medical surgery, a wireless terminal in smart grid, a wireless terminal in transportation safety, a wireless terminal in a smart city, or a wireless terminal in a smart home.

The network device in embodiments of this disclosure is a radio access network (RAN) node (or device) that connects a terminal to a wireless network, and may also be referred to as a base station or an access network device. For example, the network device may be an evolved NodeB (eNodeB), a transmission reception point (TRP), a next-generation base station (next-generation NodeB, gNB) in a 5G mobile communication system, a base station in a future mobile communication system or an access point (AP) in a Wi-Fi system, a wireless controller in a cloud radio access network (CRAN) scenario, a relay station, an access point, an on-board device, a wearable device, or a network device in another future evolved communication system.

In a possible scenario, a plurality of RAN nodes cooperatively assist a terminal in implementing radio access, and different RAN nodes separately implement some functions of the base station. For example, the RAN node (for example, the network device) may be a central unit (CU), a distributed unit (DU), a CU-control plane (CP), a CU-user plane (UP), or a radio unit (RU). The CU and the DU may be separately arranged, or may be included in a same network element, for example, in a baseband unit (BBU). The RU may be included in a radio frequency device or a radio frequency unit, for example, included in a remote radio unit (RRU), an active antenna unit (AAU), or a remote radio head (RRH). In different systems, the CU (or the CU-CP and the CU-UP), the DU, or the RU may also have different names, but a person skilled in the art may understand meanings of the names. For example, in an open radio access network (ORAN) system, the CU may also be referred to as an O-CU (open CU), the DU may also be referred to as an O-DU, the CU-CP may also be referred to as an O-CU-CP, the CU-UP may also be referred to as an O-CU-UP, and the RU may also be referred to as an O-RU. Any one of the CU (or the CU-CP and the CU-UP), the DU, and the RU may be implemented through a software module, a hardware module, or a combination of the software module and the hardware module. It should be understood that, a specific technology and a specific device form used by a network device are not limited in this disclosure.

This disclosure is intended to resolve a problem of a limited communication capacity and limited resolution caused by a fixed size of an antenna panel. The solutions provided in this disclosure are described below.

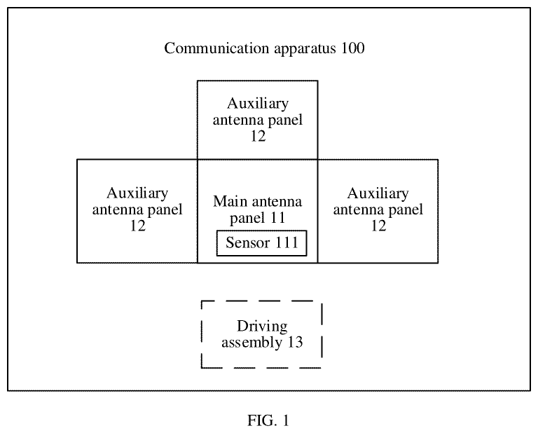

FIG. 1 is a diagram of a communication apparatus according to an embodiment. The communication apparatus 100 may be the foregoing network device. However, this is not limited in this disclosure. For example, the communication apparatus 100 may alternatively be an apparatus such as a satellite used for non-terrestrial communication. Refer to FIG. 1. The communication apparatus 100 includes a main antenna panel 11 and at least one auxiliary antenna panel 12.

The main antenna panel 11 is in a deployed configuration. The main antenna panel 11 is in the deployed configuration when performing signal transmission. In other words, the main antenna panel 11 can perform signal transmission, for example, receive and/or send a signal, when the main antenna panel is in the deployed configuration. However, it should be understood that, this disclosure does not impose a limitation that the main antenna panel 11 necessarily performs signal transmission when the main antenna panel 11 is in the deployed configuration. In other words, the main antenna panel 11 may alternatively not perform signal transmission when the main antenna panel 11 is in the deployed configuration.

The auxiliary antenna panel 12 includes a deployed configuration and a stowed configuration. The configuration of the auxiliary antenna panel 12 may be controlled by the communication apparatus 100. At a same moment, the auxiliary antenna panel 12 is in one of the deployed configuration and the stowed configuration. Similar to the main antenna panel 11, the auxiliary antenna panel 12 is in the deployed configuration when performing signal transmission. In addition, when the auxiliary antenna panel 12 is in the stowed configuration, the auxiliary antenna panel 12 cannot perform signal transmission. It should be understood that, this disclosure does not impose a limitation that the auxiliary antenna panel 12 necessarily performs signal transmission when the auxiliary antenna panel 12 is in the deployed configuration. In other words, the auxiliary antenna panel 12 may alternatively not perform signal transmission when the auxiliary antenna panel 12 is in the deployed configuration.

It should be understood that a quantity of auxiliary antenna panels is not limited in this disclosure. The communication apparatus 100 may include any quantity of auxiliary antenna panels. In FIG. 1, three auxiliary antenna panels are used merely as an example.

It should be understood that, the deployed configuration described in this disclosure may be a configuration of an existing or a future antenna panel for performing signal transmission or a signal operation.

For example, in the deployed configuration, the auxiliary antenna panel 12 and the main antenna panel 11 are on a same plane, or an angle between the auxiliary antenna panel 12 and the main antenna panel 11 is 0 degrees or approximates 0 degrees.

For example, when the auxiliary antenna panel 12 is in the stowed configuration, the main antenna panel 11 is perpendicular to the auxiliary antenna panel 12, or the auxiliary antenna panel 12 is located directly behind the main antenna panel 11.

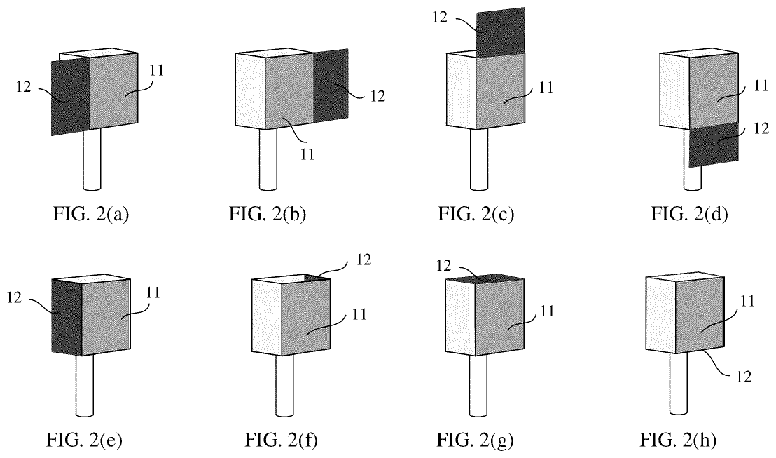

For example, FIG. 2(a) to FIG. 2(h) show diagrams of relative position relationships between the auxiliary antenna panel 12 and the main antenna panel 11 when the auxiliary antenna panel 12 is in the deployed configuration and the stowed configuration. FIG. 2(a) to FIG. 2(d) respectively show diagrams of position relationships between the auxiliary antenna panel 12 in the deployed configuration and the main antenna panel 11. FIG. 2(e) to FIG. 2(h) successively show diagrams of relative position relationships between the auxiliary antenna panel 12 in the stowed configuration in FIG. 2(a) to FIG. 2(d) and the main antenna panel 11. It should be understood that, if the auxiliary antenna panel 12 shown in FIG. 2(e) is defined as being located at the left rear of the main antenna panel 11, the auxiliary antenna panel 12 shown in FIG. 2(f) is located at the right rear of the main antenna panel 11; and if the auxiliary antenna panel 12 shown in FIG. 2(g) is defined as being located at the upper rear of the main antenna panel 11, the auxiliary antenna panel 12 shown in FIG. 2(h) is located at the lower rear of the main antenna panel 11. It should be further understood that, the auxiliary antenna panel 12 in the stowed configuration in FIG. 2(a) to FIG. 2(d) may also be located directly behind the main antenna panel 11. It should be understood that, a magnitude relationship between a size of the auxiliary antenna panel 12 and a size of the main antenna panel 11 is not limited in this disclosure, and a magnitude relationship between sizes of a plurality of auxiliary antenna panels 12 is also not limited when the communication apparatus 100 includes the plurality of auxiliary antenna panels 12, where the sizes of the plurality of the auxiliary antenna panels 12 may be the same or different.

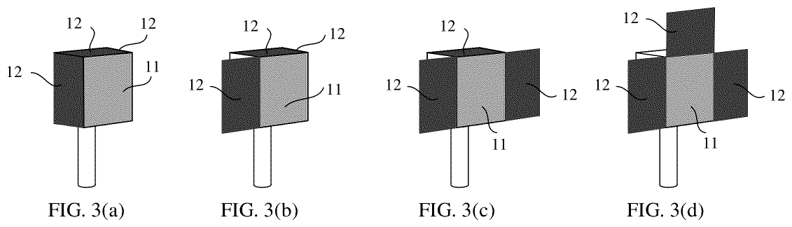

For example, an example in which the communication apparatus 100 includes three auxiliary antenna panels is used. FIG. 3(a) to FIG. 3(d) show diagrams of possible forms of an antenna panel of the communication apparatus. In FIG. 3(a), the three auxiliary antenna panels 12 are all in a stowed configuration. In FIG. 3(b), one auxiliary antenna panel 12 is in a deployed configuration, and two auxiliary antenna panels 12 are in a stowed configuration. In FIG. 3(c), two auxiliary antenna panels 12 are in a deployed configuration, and one auxiliary antenna panel 12 is in a stowed configuration. In FIG. 3(d), the three auxiliary antenna panels 12 are all in a deployed configuration.

In some embodiments, the auxiliary antenna panel 12 may be directly or indirectly connected to the main antenna panel 11.

In some embodiments, the auxiliary antenna panel 12 is movably connected (or referred to as rotatably connected) to the main antenna panel 11. In the manner, the auxiliary antenna panel is movably connected to the main antenna panel, so that the configuration of the auxiliary antenna panel is adjusted by adjusting the angle (for example, an included angle) between the main antenna panel and the auxiliary antenna panel, to adjust a size (an equivalent size) of an antenna panel.

For example, the auxiliary antenna panel 12 may be connected to the main antenna panel 11 through a component that supports 360-degree or 180-degree free movement.

For example, refer to FIG. 4. The auxiliary antenna panel 12 may be connected to the main antenna panel 11 through a shaft 101, and the auxiliary antenna panel 12 may achieve 360-degree free rotation about the shaft 101 that connects the main antenna panel 11. The communication apparatus 100 may control, by controlling rotation of the shaft 101, the auxiliary antenna panel 12 to be in the stowed configuration or the deployed configuration.

It should be noted that, the component that connects the auxiliary antenna panel 12 and the main antenna panel 11 is not limited in this disclosure, provided that the included angle between the auxiliary antenna panel 12 and the main antenna panel 11 can be adjusted. In addition, an adjustable angle between the auxiliary antenna panel 12 and the main antenna panel 11 is not limited in this disclosure. For example, the angle may be 360 degrees or 180 degrees, or may be 90 degrees.

In some embodiments, the auxiliary antenna panel 12 is connected to the main antenna panel 11 through a telescopic component.

In the solution, a telescopic length of the auxiliary antenna panel 12 relative to the main antenna panel 11 may be controlled by controlling the telescopic component, so that the auxiliary antenna panel is in the deployed configuration or in the stowed configuration. In other words, according to the solution, the configuration of the auxiliary antenna panel can be adjusted by controlling the telescopic length of the auxiliary antenna panel 12 relative to the main antenna panel 11, to adjust a size (an equivalent size) of an antenna panel.

For example, when the telescopic length of the auxiliary antenna panel 12 relative to the main antenna panel 11 is 0, the main antenna panel 11 completely occludes the auxiliary antenna panel 12. In this case, the auxiliary antenna panel 12 is in the stowed configuration. When the telescopic length of the auxiliary antenna panel 12 relative to the main antenna panel 11 is a maximum telescopic length, a relative position relationship between the auxiliary antenna panel 12 and the main antenna panel 11 may be as shown in any one of the accompanying drawings in FIG. 2(a) to FIG. 2(h).

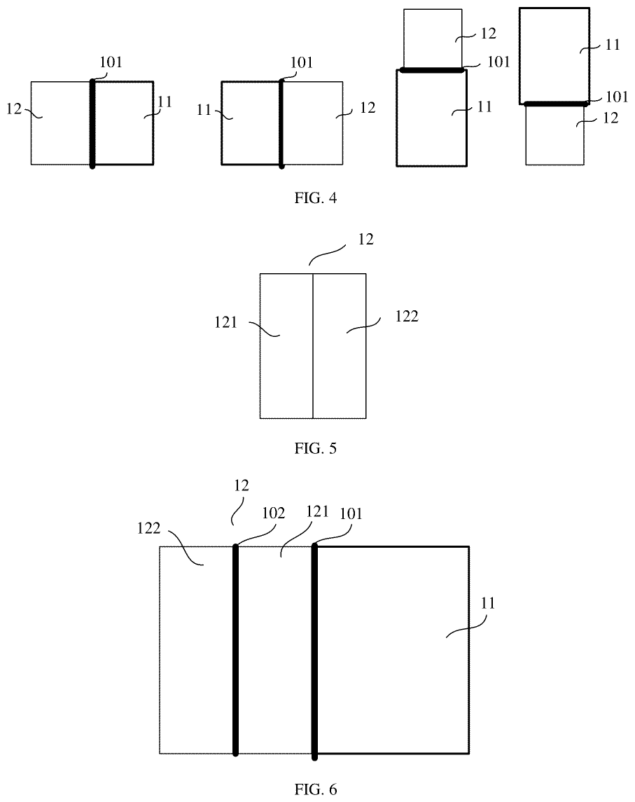

In some embodiments, refer to FIG. 5. The auxiliary antenna panel 12 includes a first sub-antenna panel 121 and a second sub-antenna panel 122. The first sub-antenna panel 121 is movably connected to the main antenna panel 11 or the first sub-antenna panel 121 is connected to the main antenna panel 11 through a telescopic component, and the second sub-antenna panel 122 is movably connected to the first sub-antenna panel 121 or the second sub-antenna panel 122 is connected to the first sub-antenna panel 121 through a telescopic component.

Regarding connection forms between the first sub-antenna panel 121 and the main antenna panel 11 and between the first sub-antenna panel 121 and the second sub-antenna panel 122, refer to the foregoing manner of a connection between the auxiliary antenna panel 12 and the main antenna panel 11. Details are not described herein again.

For example, refer to FIG. 6. The first sub-antenna panel 121 may be connected to the main antenna panel 11 through a shaft 101, and the auxiliary antenna panel 12 may achieve 360-degree free rotation about the shaft 101. The second sub-antenna panel 122 may be connected to the first sub-antenna panel 121 through a shaft 102, and the second sub-antenna panel 122 may achieve 360-degree free rotation about the shaft 102. The communication apparatus 100 may control, by controlling rotation of the shaft 101, the first sub-antenna panel 121 to be in the stowed configuration or the deployed configuration, and may control, by controlling rotation of the shaft 102, the second sub-antenna panel 122 to be in the stowed configuration or the deployed configuration.

It should be noted that, sizes of the first sub-antenna panel and the second sub-Clean antenna panel are not limited in this disclosure, and the size of the first sub-antenna panel may be the same as or different from that of the second sub-antenna panel.

In some embodiments, the communication apparatus 100 may further include a driving assembly 13. The driving assembly 13 drives the component that connects the auxiliary antenna panel 12 and the main antenna panel 11 to change the configuration of the auxiliary antenna panel 12.

For example, the driving assembly 13 may be a motor. For example, the motor may drive the shaft 101 shown in FIG. 4 or drive the telescopic component described above.

In some embodiments, a sensor is arranged on the main antenna panel 11 and/or a part or all of the at least one auxiliary antenna panel 12. The sensor is configured to collect wind speed information. For example, the sensor may be a wind speed sensor.

For example, refer to FIG. 1. A sensor 111 may be arranged on the main antenna panel 11. It should be understood that the sensor may be arranged on the main antenna panel 11 and a part or all of the auxiliary antenna panel 12, or the sensor may be arranged on a part or all of the auxiliary antenna panel 12.

The method is described below with reference to the communication apparatus 100 described above. It should be understood that, the method may be performed by the foregoing communication apparatus 100 or a module, a chip, a computer program, or the like arranged in the communication apparatus 100. An example in which the method is performed by the communication apparatus 100 is used for description below.

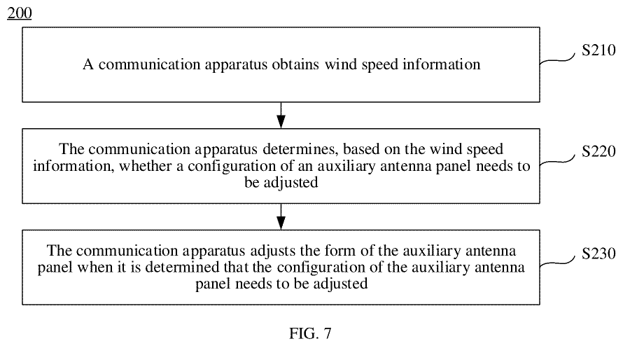

FIG. 7 is a schematic flowchart of an antenna control method according to an embodiment. The method 200 includes S210 to S230, and each step is described below.

S210: A communication apparatus obtains wind speed information.

For example, as described above, a sensor may be arranged on the main antenna panel and/or a part or all of the at least one auxiliary antenna panel, and the sensor may collect the wind speed information. For example, the sensor is a wind speed sensor.

For example, the wind speed information may be wind speed-related information obtained by processing information collected by the sensor.

In an example, the communication apparatus may periodically obtain the wind speed information. For example, the sensor may periodically obtain the wind speed information.

In an example, if wind speed information currently obtained by the sensor is different from wind speed information obtained last time, the wind speed information is reported to the communication apparatus.

For example, the wind speed information may be a wind speed force, information related to the wind speed force, or any information that can represent a wind speed.

S220: The communication apparatus determines, based on the wind speed information, whether to adjust a configuration of an auxiliary antenna panel.

For example, the communication apparatus may store a correspondence between the wind speed information and a configuration of an antenna panel, and the communication apparatus may determine, depending on whether a current configuration of the antenna panel is a target configuration corresponding to the wind speed information, whether to adjust the configuration of the auxiliary antenna panel. If the current configuration of the antenna panel is not the target configuration corresponding to the wind speed information, the configuration of the auxiliary antenna panel is to be adjusted; otherwise, the configuration of the auxiliary antenna panel is not to be adjusted. Adjusting the configuration of the auxiliary antenna panel is adjusting a configuration of a part or all of the at least one auxiliary antenna panel.

For example, S220 is performed when the wind speed information changes. S220 is performed when the currently obtained wind speed information is different from the wind speed information obtained last time.

S230: The communication apparatus adjusts the configuration of the auxiliary antenna panel when it is determined to adjust that the configuration of the auxiliary antenna panel.

For example, if it is determined in S220 to adjust the configuration of the auxiliary antenna panel, the configuration of a part or all of the at least one auxiliary antenna panel is adjusted, so that the configuration of the antenna panel after adjustment is the target configuration corresponding to the wind speed information. If it is determined in S220 not to adjust the configuration of the auxiliary antenna panel, no operation may be performed.

An example in which the communication apparatus includes a main antenna panel 11 and three auxiliary antenna panels 12A, 12B, and 12C, and the auxiliary antenna panels 12A, 12B, and 12C in a deployed state are respectively located above, on the left, and on the right of the main antenna panel 11 is used for description.

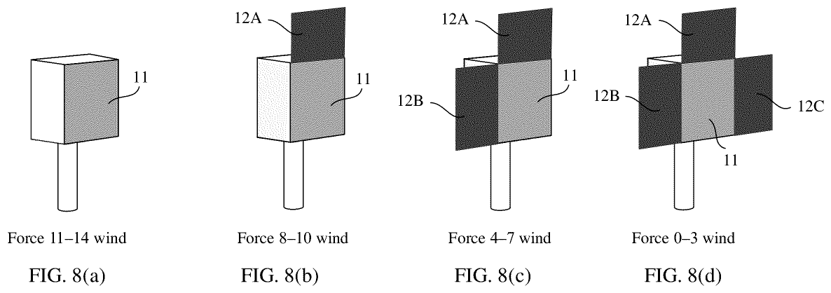

In an example, refer to FIG. 8(a). When the wind speed force is any one of forces 11-14, no auxiliary antenna panel is to be deployed. The target configuration is that the main antenna panel 11 is in the deployed state. Refer to FIG. 8(b). When the wind speed force is any one of forces 8-10, the auxiliary antenna panel 12A may be deployed. The target configuration is that the main antenna panel 11 and the auxiliary antenna panel 12A (or any auxiliary antenna panel or an auxiliary antenna panel in a specific direction) are in the deployed state. Refer to FIG. 8(c). When the wind speed force is any one of forces 4-7, the auxiliary antenna panels 12A and 12B may be deployed. The target configuration is that the main antenna panel 11 and the auxiliary antenna panels 12A and 12B (or any two auxiliary antenna panels or auxiliary antenna panels in specific directions) are in the deployed state. Refer to FIG. 8(d). When the wind speed force is any one of forces below a force 4 (for example, forces 0-3), the auxiliary antenna panels 12A, 12B, and 12C may be deployed. The target configuration is that the main antenna panel 11 and all the auxiliary antenna panels are all in the deployed state.

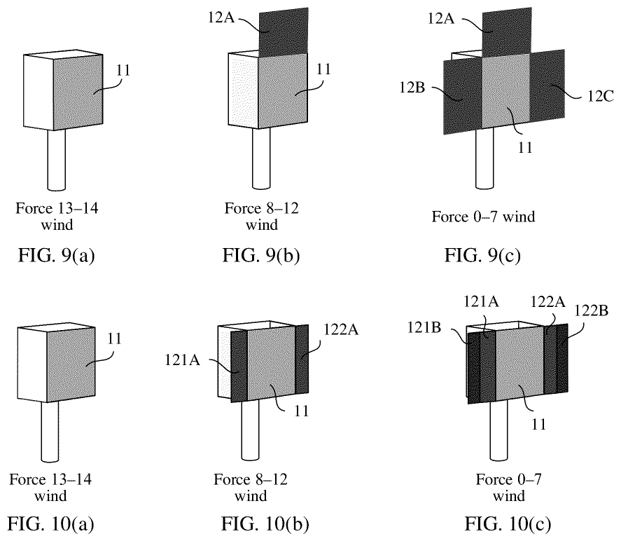

In another example, refer to FIG. 9(a). When the wind speed force is a force 13 or 14, no auxiliary antenna panel is to be deployed. Refer to FIG. 9(b). When the wind speed force is any one of forces 8-12, the auxiliary antenna panel 12A may be deployed. Refer to FIG. 9(c). When the wind speed force is any one of forces below a force 8 (for example, forces 0-7), the auxiliary antenna panels 12A, 12B, and 12C may be deployed.

An example in which the communication apparatus includes a main antenna panel 11 and two auxiliary antenna panels 12A and 12B, and the two auxiliary antenna panels each include the first sub-antenna panel and the second sub-antenna panel described above is used for description. In an example, refer to FIG. 10(a). When the wind speed force is a force 13 or 14, no auxiliary antenna panel is to be deployed. Refer to FIG. 10(b). When the wind speed force is any one of forces 8-12, a first sub-antenna panel 121A in the auxiliary antenna panel 12A and a first sub-antenna panel 122A in the auxiliary antenna panel 12B may be deployed. Refer to FIG. 10(c). When the wind speed force is any one of forces below a force 8 (for example, forces 0-7), a first sub-antenna panel 121A and a second sub-antenna panel 121B in the auxiliary antenna panel 12A and a first sub-antenna panel 122A and a second sub-antenna panel 122B in the auxiliary antenna panel 12B may be deployed.

A current size of an antenna panel is required to satisfy wind resistance of force-14 wind. However, force-14 wind occurs only once in several decades, and the wind speed is below a force 4 for most of the time. The communication apparatus can support an antenna panel of a larger size (or area) during most periods. According to the antenna control method, the configuration of the auxiliary antenna panel may be flexibly adjusted based on the wind speed information, to increase a size of the antenna panel as much as possible while satisfying a requirement of wind resistance on the size of the antenna panel, further improve a communication capacity and resolution, expand a scanning range as much as possible in an integrated sensing and communication scenario, and improve sensing performance.

It should be understood that, for the auxiliary antenna panel, the main antenna panel, and how to adjust the configuration of the auxiliary antenna panel, refer to the related descriptions in the descriptions of the communication apparatus 100. Details are not described herein again.

In some embodiments, before S220, the method further includes: The communication apparatus obtains service information. Correspondingly, in S220, the communication apparatus determines, based on the obtained wind speed information and service information, whether to adjust the configuration of the auxiliary antenna panel.

For example, the service information may be one or more of the following: a quantity of terminals connected to the communication apparatus, a current throughput of the communication apparatus, or a current data transmission rate.

For example, when the wind speed force is any one of forces below a force 7, if the current data transmission rate is less than a preset threshold #1, all auxiliary antenna panels may be deployed. For example, when the wind speed force is any one of forces below a force 4, if the quantity of terminals connected to the communication apparatus is greater than a preset threshold #2, all auxiliary antenna panels may be deployed. When the wind speed force is any one of forces below a force 7, if the quantity of terminals connected to the communication apparatus is greater than a preset threshold #3, some auxiliary antenna panels may be deployed.

According to the antenna control method, the configuration of the auxiliary antenna panel is adjusted based on the wind speed information and the service information, so that the size of the antenna panel can be increased as much as possible while satisfying current requirements of the wind speed information and the service information, to improve a communication capacity and resolution, expand a scanning range as much as possible in the integrated sensing and communication scenario, and improve sensing performance. For example, when the wind speed is low, one or more auxiliary antenna panels may be properly deployed while satisfying a service requirement, to increase the size of the antenna panel, and improve a channel capacity and resolution.

The communication method is described above. Some communication apparatuses are described below with reference to the foregoing method.

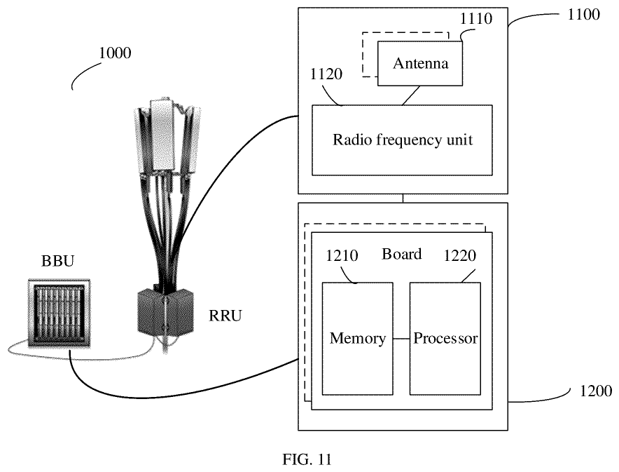

FIG. 11 shows a diagram of a structure of a network device according to an embodiment. The communication apparatus 100 may be configured in a network device 1000. Alternatively, the communication apparatus 100 may be the network device 1000. Alternatively, the network device 1000 may perform the operations performed by the communication apparatus 100 in the foregoing method embodiments.

The network device 1000 may include one or more radio frequency units, such as a remote radio unit (RRU) 1100 and one or more baseband units (BBU) (which may also be referred to as a digital unit (DU)) 1200. The RRU 1100 is configured to receive and send a radio frequency signal, and perform conversion between the radio frequency signal and a baseband signal. The RRU 1100 may be referred to as a transceiver unit, a transmitter receiver, a transceiver circuit, a transceiver, or the like. The BBU 1200 is a control center of the network device 1000, may also be referred to as a processing unit, and is configured to perform baseband processing functions such as channel coding, multiplexing, modulation, and spectrum spreading. The BBU 1200 part is configured to perform baseband processing, control the network device 1000, and the like. The RRU 1100 and the BBU 1200 may be physically arranged together, or may be physically arranged separately, for example, a distributed base station.

In an example, as shown in FIG. 11, the RRU 1100 may include at least one antenna 1110 and a radio frequency unit 1120. In an example, the at least one antenna 1110 may be independent of the RRU 1100, and the at least one antenna 1110 may be connected to the RRU 1100 through a feeder line.

For example, the antenna 1110 may include the main antenna panel 11 and the at least one auxiliary antenna panel 12 described above. For details about the main antenna panel 11 and the at least one auxiliary antenna panel 12, refer to the foregoing descriptions. Details are not described herein again. For example, the antenna 1110 may include the sensor described above. After collecting wind speed information, the sensor may transmit the wind speed information to the BBU 1200, and the BBU 1200 may perform, based on the wind speed information, the operations performed by the communication apparatus in the foregoing method 200.

In an example, the BBU 1200 may include one or more boards. A plurality of boards may jointly support a radio access network (for example, an LTE system or a 1G system) of a single access standard, or may respectively support radio access networks of different access standards. The BBU 1200 further includes a memory 1210 and a processor 1220. The memory 1210 is configured to store instructions and data. The processor 1220 is configured to control the network device 1000 to perform an action, for example, configured to control the network device 1000 to perform the operations performed by the communication apparatus in the foregoing method 200. The memory 1210 and the processor 1220 may serve one or more boards. In other words, a memory and a processor may be separately arranged on each board. Alternatively, a plurality of boards may share a same memory and processor. In addition, a circuit may be further arranged on each board.

In some embodiments, with the development of a system-on-chip (SoC) technology, all or a part of functions of the 1200 part and the 1100 part may be implemented through the SoC technology, for example, implemented through a base station function chip. The base station function chip integrates devices such as a processor, a memory, and an antenna port. A program of a base station-related function is stored in the memory, and the processor executes the program to implement the base station-related function. In some embodiments, the base station function chip can also read a memory outside the chip to implement relevant functions of a base station.

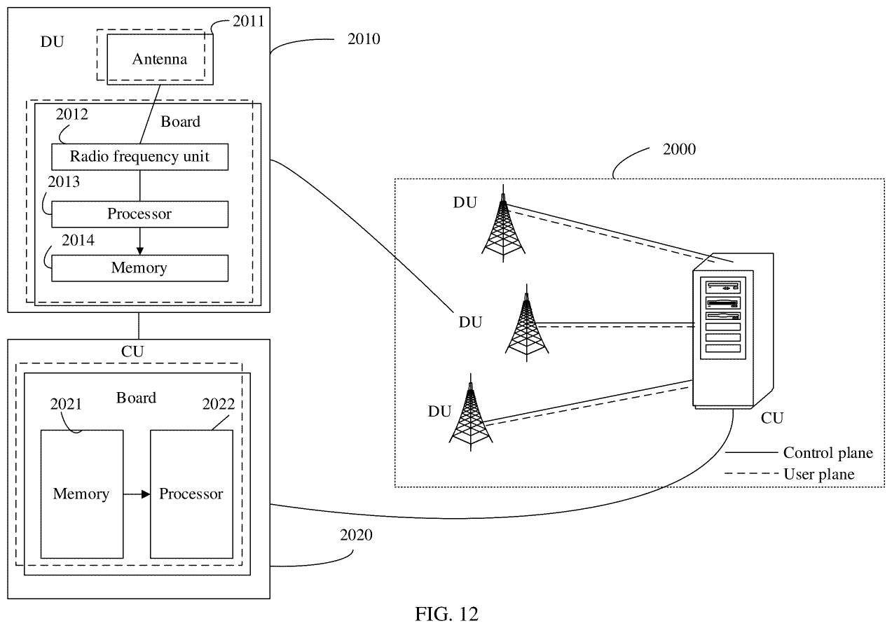

FIG. 12 is a diagram of a structure of a network device 2000 according to an embodiment. The communication apparatus 100 may be configured in the network device 2000. Alternatively, the communication apparatus 100 may be the network device 2000. Alternatively, the network device 2000 may perform the action performed by the communication apparatus in the foregoing method embodiments.

As shown in FIG. 12, the network device 2000 may include one or more DUs 2010 and one or more CUs 2020. The CU 2020 may communicate with an NG core (next-generation core network (NC)).

The DU 2010 may include at least one antenna 2011, at least one radio frequency unit 2012, at least one processor 2013, and at least one memory 2014. For example, the antenna 2011 may include the main antenna panel 11 and the at least one auxiliary antenna panel 12 described above. For details about the main antenna panel 11 and the at least one auxiliary antenna panel 12, refer to the foregoing descriptions. Details are not described herein again. For example, the antenna 2011 may include the sensor described above. After collecting wind speed information, the sensor may transmit the wind speed information to the CU 2020, and the CU 2020 may perform, based on the wind speed information, the operations performed by the communication apparatus in the foregoing method 200.

The DU 2010 part is configured to receive/send a radio frequency signal, perform conversion between the radio frequency signal and a baseband signal, and perform partial baseband processing. The CU 2020 may include at least one processor 2022 and at least one memory 2021. The CU 2020 and the DU 2010 may perform communication through an interface. A control plane (CP) interface may be an Fs-C, for example, an F1-C, and a user plane (UP) interface may be an Fs-U, for example, an F1-U.

The CU 2020 part is configured to perform baseband processing, control the network device 2000, and the like. The DU 2010 and the CU 2020 may be physically arranged together, or may be physically separated, for example, a distributed base station. The CU 2020 is a control center of the network device 2000, may also be referred to as a processing unit, and is configured to complete a baseband processing function. For example, the CU 2020 may be configured to control the network device 2000 to perform the operations performed by the communication apparatus in the method 200.

Baseband processing performed by the CU and the DU may be divided based on protocol layers of a wireless network. For example, functions of a PDCP layer and protocol layers above the PDCP layer are set on the CU, and functions of protocol layers below PDCP, such as an RLC layer and a MAC layer, are set on the DU. For another example, the CU implements functions of an RRC layer and the PDCP layer, and the DU implements functions of the RLC layer, the MAC layer, and a PHY layer.

In addition, in some embodiments, the network device 2000 may include one or more radio units (RU), one or more DUs, and one or more CUs. The DU may include at least one processor 2013 and at least one memory 2014, the RU may include at least one antenna 2011 and at least one radio frequency unit 2012, and the CU may include at least one processor 2022 and at least one memory 2021.

In an example, the CU 2020 may include one or more boards. A plurality of boards can jointly support a radio access network (for example, a 3G network) of a single access indication standard, or may respectively support radio access networks (for example, an LTE network, a 3G network, or another network) of different access standards. The memory 2021 and the processor 2022 may serve one or more boards. In other words, a memory and a processor may be separately arranged on each board. Alternatively, a plurality of boards may share a same memory and processor. In addition, a circuit may be further arranged on each board. The DU 2010 may include one or more boards. A plurality of boards can jointly support a radio access network (for example, a 3G network) of a single access standard, or may respectively support radio access networks (for example, an LTE network, a 3G network, or another network) of different access standards. The memory 2014 and the processor 2013 may serve one or more boards. In other words, a memory and a processor may be separately arranged on each board. Alternatively, a plurality of boards may share a same memory and processor. In addition, a circuit may be further arranged on each board.

It should be understood that, the network device 2000 shown in FIG. 12 can implement various processes of an action performed by the communication apparatus in the foregoing method 200. Operations and/or functions of the modules in the network device 2000 are intended to implement the corresponding processes in the foregoing method embodiments. For details, refer to the descriptions in the foregoing method embodiments. To avoid repetition, detailed descriptions are appropriately omitted herein.

It should be understood that, the network devices shown in FIG. 11 and FIG. 12 are merely two possible architectures of the communication apparatus, and should not constitute any limitation on this disclosure. The methods may be applicable to a network device in another architecture, for example, a network device including a CU, a DU, and an AAU. A specific architecture of the communication apparatus is not limited in this disclosure.

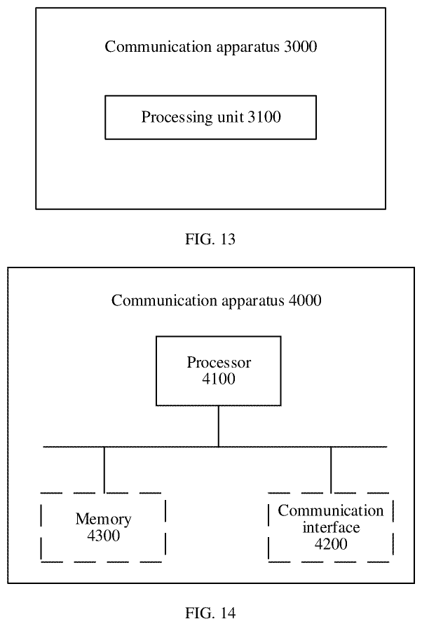

FIG. 13 is a block diagram of a communication apparatus according to an embodiment. As shown in FIG. 13, a communication apparatus 3000 may include a processing unit 3100. In some embodiments, the communication apparatus 3000 further includes the main antenna panel 11 and the at least one auxiliary antenna panel 12 described above. The processing unit 3100 may implement a corresponding processing function. In some embodiments, the communication apparatus 3000 may further include a storage unit. The storage unit may be configured to store instructions and/or data. The processing unit 3100 may read the instructions and/or the data in the storage unit, to enable the communication apparatus 3000 to implement the foregoing method embodiments.

The communication apparatus 3000 may be the communication apparatus in the foregoing method 200, or may be a module or a chip used in the communication apparatus in the method 200. The communication apparatus 3000 may be configured to perform the steps or the processes performed by the communication apparatus in the method 200.

The processing unit 3100 is configured to: obtain wind speed information; and determine, based on the wind speed information, whether to adjust a configuration of an auxiliary antenna panel, where the configuration of the auxiliary antenna panel includes a deployed configuration and a stowed configuration, an antenna panel is in the deployed configuration when the antenna panel performs signal transmission, the antenna panel includes a main antenna panel and the auxiliary antenna panel, and the main antenna panel is in the deployed configuration; and the processing unit is further configured to adjust the configuration of the auxiliary antenna panel when it is determined to adjust the configuration of the auxiliary antenna panel.

In some embodiments, the processing unit 3100 is further configured to obtain service information, and determine, based on the wind speed information and the service information, whether to adjust the configuration of the auxiliary antenna panel.

In some embodiments, the main antenna panel is movably connected to the auxiliary antenna panel, and the processing unit 3100 is configured to adjust an angle between the auxiliary antenna panel and the main antenna panel.

In some embodiments, the auxiliary antenna panel is connected to the main antenna panel through a component that supports 360-degree free movement.

In some embodiments, the auxiliary antenna panel includes a first sub-antenna panel and a second sub-antenna panel. The first sub-antenna panel is movably connected to the main antenna panel, and the second sub-antenna panel is movably connected to the first sub-antenna panel.

In some embodiments, the main antenna panel is connected to the auxiliary antenna panel through a telescopic component. The processing unit 3100 is configured to:
adjust a telescopic length of the auxiliary antenna panel relative to the main antenna panel.

In some embodiments, the auxiliary antenna panel includes a first sub-antenna panel and a second sub-antenna panel. The first sub-antenna panel is connected to the main antenna panel through a telescopic component, and the second sub-antenna panel is connected to the first sub-antenna panel through a telescopic component.

For details about the steps or processes performed by the units in the communication apparatus 3000, refer to the foregoing method embodiments. Details are not described herein again.

It should be understood that the “unit” in the communication apparatus 3000 may be implemented by hardware, or may be implemented by software, or may be implemented by hardware executing corresponding software. For example, the “unit” herein may be an application-specific integrated circuit (ASIC), an electronic circuit, a processor (for example, a shared processor, a dedicated processor, or a group processor) for executing one or more software or firmware programs, a memory, a combinational logic circuit, and/or another suitable component that supports the described functions. For another example, the processing unit 3100 may be replaced with a processor or a processing circuit.

FIG. 14 is a block diagram of another communication apparatus 4000 according to an embodiment. The communication apparatus 400 may be a network device (for example, a network device 1000 or a network device 2000) or the communication apparatus 100 or the communication apparatus 3000, or may be a chip, a chip system, a processor, or the like that supports the network device (for example, the network device 1000 or the network device 2000) or the communication apparatus 100 or the communication apparatus 3000 to implement the foregoing method. The communication apparatus 4000 may be configured to implement the method described in the foregoing method embodiments. For details, refer to the descriptions in the foregoing method embodiments.

The communication apparatus 4000 may include one or more processors 4100. The processor 4100 may also be referred to as a processing unit, and may implement a specific control function. The processor 4100 may be a general-purpose processor, a special-purpose processor, or the like. For example, the processor may be a baseband processor or a central processing unit. The baseband processor may be configured to process a communication protocol and communication data. The central processing unit may be configured to control the communication apparatus (such as a base station, a baseband chip, a user, a user chip, a DU, or a CU), execute a software program, and process data of the software program.

In some embodiments, the processor 4100 may also store instructions and/or data, and the instructions and/or the data may be run by the processor 4100, to enable the communication apparatus 4000 to perform the method described in the foregoing method embodiments.

In some embodiments, the communication apparatus 4000 may include a communication interface 4200 for implementing receiving and sending functions. For example, the communication interface 4200 may be a transceiver circuit, an interface, an interface circuit, or a transceiver. The transceiver circuit, the interface, the interface circuit, or the transceiver for implementing the receiving and sending functions may be separated, or may be integrated together. The transceiver circuit, the interface, the interface circuit, or the transceiver may be configured to read and write code/data, or the transceiver circuit, the interface, the interface circuit, or the transceiver may be configured to transmit or transfer a signal.

In some embodiments, the communication apparatus 4000 may include one or more memories 4300, and the one or more memories may store instructions. The instructions may be run on the processor 4100, to enable the communication apparatus 4000 to perform the method described in the foregoing method embodiments. In some embodiments, the memory 4300 may further store data. In some embodiments, the processor 4100 may also store instructions and/or data. The processor 4100 and the memory 4300 may be separately arranged, or may be integrated together.

It should be understood that the steps in the foregoing method embodiments may be completed through an integrated logic circuit of hardware in the processor or instructions in a form of software. The steps of the method disclosed with reference to embodiments may be directly performed by a hardware processor, or may be performed using a combination of hardware in the processor and a software module. The software module may be located in a mature storage medium in the art, such as a random access memory, a flash memory, a read-only memory, a programmable read-only memory, an electrically erasable programmable memory, or a register. The storage medium is located in the memory, and a processor reads information in the memory and completes the steps in the foregoing methods in combination with hardware of the processor. To avoid repetition, details are not described herein again.

It should be noted that, the processor in embodiments may be an integrated circuit chip, and has a signal processing capability. In a process, the steps in the foregoing method embodiments may be completed through an integrated logic circuit of hardware in the processor or instructions in the form of software. The processor may be a general-purpose processor, a digital signal processor (DSP), an application-specific integrated circuit (ASIC), a field programmable gate array (FPGA) or another programmable logic device, a discrete gate or a transistor logic device, or a discrete hardware component. The general-purpose processor may be a microprocessor, or the processor may be any conventional processor, or the like. The steps of the method disclosed with reference to embodiments may be directly performed by a hardware decoding processor, or may be performed using a combination of hardware in the decoding processor and the software module. The software module may be located in a mature storage medium in the art, such as a random access memory, a flash memory, a read-only memory, a programmable read-only memory, an electrically erasable programmable memory, or a register. The storage medium is located in the memory, and a processor reads information in the memory and completes the steps in the foregoing methods in combination with hardware of the processor.

It may be understood that, the memory in embodiments may be a volatile memory or a nonvolatile memory, or may include both the volatile memory and the nonvolatile memory. The nonvolatile memory may be a read-only memory (ROM), a programmable read-only memory (programmable ROM, PROM), an erasable programmable read-only memory (erasable PROM, EPROM), an electrically erasable programmable read-only memory (electrically EPROM, EEPROM), or a flash memory. The volatile memory may be a random access memory (RAM) serving as an external cache. Through illustrative but not restrictive description, many forms of RAMs are used, for example, a static random access memory (static RAM, SRAM), a dynamic random access memory (dynamic RAM, DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchronous link dynamic random access memory (synchlink DRAM, SLDRAM), and a direct rambus dynamic random access memory (direct rambus RAM, DR RAM). It should be noted that, the memories of the system and the method described herein are intended to include, but are not limited to, these and any other suitable types of memories.

This disclosure further provides an antenna. The antenna includes the main antenna panel 11 and at least one auxiliary antenna panel 12 described above. For details about the main antenna panel 11 and the at least one auxiliary antenna panel 12, refer to the foregoing descriptions. Details are not described herein again. For example, the antenna may include the sensor described above.

This disclosure further provides a computer program product. The computer program product includes computer program code. When the computer program code is run on a computer, the computer is enabled to perform the steps or the processes performed by the communication apparatus in the foregoing method embodiments.

This disclosure further provides a non-transitory computer-readable storage medium. The non-transitory computer-readable storage medium stores program code. When the program code is run on a computer, the computer is enabled to perform the steps or the processes performed by the communication apparatus in the foregoing method embodiments.

This disclosure further provides a communication apparatus, including a processor and an interface. The interface is configured to send and/or receive a signal, to enable the processor to perform the steps or the processes performed by the communication apparatus in the foregoing method embodiments.

The foregoing various apparatus embodiments completely correspond to the method embodiments, and corresponding modules or units perform corresponding steps. For example, a communication unit or a communication interface performs a step of receiving or sending in the method embodiments, and a processing unit or a processor may perform a step other than the step of receiving or sending.

In embodiments of this disclosure, all terms and English abbreviations are provided as illustrative examples for convenience of description, and shall not constitute any limitation on this disclosure. This disclosure does not exclude a possibility of defining another term that can implement same or similar functions in an existing or future protocol.

A term such as “component”, “module”, or “system” used in this specification is used to indicate a computer-related entity, hardware, firmware, a combination of hardware and software, software, or software being executed. For example, a component may be, but is not limited to, a process that runs on a processor, a processor, an object, an executable file, a thread of execution, a program, and/or a computer. As shown in the figures, both an application and a computing device that runs on a computing device may be components. One or more components may reside within a process and/or a thread of execution, and a component may be located on one computer and/or distributed between two or more computers. In addition, these components may be executed from a variety of computer-readable storage media having various data structures stored thereon. The components may communicate through a local and/or remote process, for example, based on a signal having one or more data packets (for example, data from two components interacting with another component in a local system, a distributed system, and/or across a network such as the Internet interacting with another system through the signal).

A person of ordinary skill in the art may be aware that, various illustrative logical blocks and steps described in combination with the embodiments disclosed in this specification can be implemented by electronic hardware or a combination of computer software and electronic hardware. Whether the functions are performed by hardware or software depends on specific applications and design constraints of the technical solutions. A person skilled in the art may use different methods to implement the described functions for each specific application, but it should not be considered that such implementation goes beyond the scope of this disclosure.

It may be clearly understood by a person skilled in the art that, for the purpose of convenient and brief description, for an operating process of the foregoing system, apparatuses, and units, refer to the corresponding processes in the foregoing method embodiments, and details are not described herein again.

In the several embodiments, it should be understood that, the disclosed system, apparatus, and method may be implemented in other manners. For example, the described apparatus embodiment is merely an example. For example, division into the units is merely logical function division and may be another division during actual implementation. For example, a plurality of units or components may be combined or may be integrated into another system, or some features may be ignored or not performed. In addition, the displayed or discussed mutual coupling or direct coupling or communication connection may be implemented through some interfaces. The indirect coupling or communication connection between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected based on actual requirements to achieve the objectives of the solutions of embodiments.

In addition, functional units in embodiments may be integrated into one processing unit, each of the units may exist alone physically, or two or more units are integrated into one unit.

In the foregoing embodiments, all or some of the functions of the function units may be implemented through software, hardware, firmware, or any combination thereof. During implementation through software, all or some of embodiments may be implemented in a form of a computer program product. The computer program product includes one or more computer instructions (programs). When the computer program instructions (programs) are loaded and executed on the computer, all or part of the processes or functions according to embodiments are generated. The computer may be a general-purpose computer, a dedicated computer, a computer network, or another programmable apparatus. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, and microwave, or the like) manner. The computer-readable storage medium may be any usable medium accessible by the computer, or a data storage device such as a server or a data center integrating one or more usable media. The usable medium may be a magnetic medium (for example, a floppy disk, a hard disk, or a magnetic tape), an optical medium (for example, a DVD), or a semiconductor medium (for example, a solid-state disk (SSD)), or the like.

When the functions are implemented in a form of a software functional unit and sold or used as an independent product, the functions may be stored in a computer-readable storage medium. Based on such an understanding, the technical solutions of this disclosure essentially, or the part contributing to the conventional technology, or a part of the technical solutions may be implemented in the form of a software product. The computer software product is stored in a storage medium, and includes several instructions for enabling a computer device (which may be a personal computer, a server, a network device, or the like) to perform all or part of the steps of the method described in embodiments. The foregoing storage medium includes: various media that can store program code, such as a USB flash drive, a removable hard disk, a read only memory (ROM), a random access memory (RAM), a magnetic disk, or a compact disc.

The foregoing descriptions are merely example implementations of this disclosure, but the protection scope of this disclosure is not limited thereto. Any variation or replacement readily figured out by a person skilled in the art within the technical scope disclosed in this disclosure shall fall within the protection scope of this disclosure. Therefore, the protection scope of this disclosure shall be subject to the protection scope of the claims.

1. An antenna control method, executed by a communication apparatus comprising a main antenna panel in a deployed configuration and at least one auxiliary antenna panel, comprising:
obtaining wind speed information;
determining, based on the wind speed information, whether to adjust a configuration of the auxiliary antenna panel, wherein the configuration of the auxiliary antenna panel comprises one of a deployed configuration and a stowed configuration, an antenna panel is in the deployed configuration for the antenna panel performing signal transmission, and the antenna panel comprises the main antenna panel and the auxiliary antenna panel; and
adjusting the configuration of the auxiliary antenna panel in response to determining to adjust the configuration of the auxiliary antenna panel

2. The antenna control method according to claim 1, further comprising:
obtaining service information, wherein
determining, based on the wind speed information, whether to adjust the configuration of the auxiliary antenna panel comprises:
determining, based on the wind speed information and the service information, whether to adjust the configuration of the auxiliary antenna panel.

3. The antenna control method according to claim 1, wherein:
the main antenna panel is movably connected to the auxiliary antenna panel; and
adjusting the configuration of the auxiliary antenna panel comprises:
adjusting an angle between the auxiliary antenna panel and the main antenna panel.

4. The antenna control method according to claim 3, wherein the auxiliary antenna panel is connected to the main antenna panel through a component that supports 360-degree free movement.

5. The antenna control method according to claim 3, wherein the auxiliary antenna panel comprises a first sub-antenna panel and a second sub-antenna panel, the first sub-antenna panel is movably connected to the main antenna panel, and the second sub-antenna panel is movably connected to the first sub-antenna panel.

6. The antenna control method according to claim 5, wherein the second sub-antenna panel is connected to the first sub-antenna panel through a component that supports 360-degree or 180-degree free movement.

7. The antenna control method according to claim 1, wherein the main antenna panel is connected to the auxiliary antenna panel through a telescopic component; and
adjusting the configuration of the auxiliary antenna panel comprises:
adjusting a telescopic length of the auxiliary antenna panel relative to the main antenna panel.

8. The antenna control method according to claim 7, wherein the auxiliary antenna panel comprises a first sub-antenna panel and a second sub-antenna panel, the first sub-antenna panel is connected to the main antenna panel through a first telescopic component, and the second sub-antenna panel is connected to the first sub-antenna panel through a second telescopic component.

9. A communication apparatus, comprising:
a processing unit configured to:
obtain wind speed information;
determine, based on the wind speed information, whether to adjust a configuration of an auxiliary antenna panel, wherein the configuration of the auxiliary antenna panel comprises one of a deployed configuration and a stowed configuration, an antenna panel is in the deployed configuration for the antenna panel performing signal transmission, the antenna panel comprises a main antenna panel and the auxiliary antenna panel, and the main antenna panel is in the deployed configuration; and
adjust the configuration of the auxiliary antenna panel in response to determining to adjust the configuration of the auxiliary antenna panel.

10. The communication apparatus according to claim 9, wherein the processing unit is further configured to:
obtain service information; and
determine, based on the wind speed information and the service information, whether to adjust the configuration of the auxiliary antenna panel.

11. The communication apparatus according to claim 9, wherein:
the main antenna panel is movably connected to the auxiliary antenna panel; and
the processing unit is further configured to:
adjust an angle between the auxiliary antenna panel and the main antenna panel.

12. The communication apparatus according to claim 11, wherein the auxiliary antenna panel is connected to the main antenna panel through a component that supports 360-degree free movement.

13. The communication apparatus according to claim 11, wherein the auxiliary antenna panel comprises a first sub-antenna panel and a second sub-antenna panel, the first sub-antenna panel is movably connected to the main antenna panel, and the second sub-antenna panel is movably connected to the first sub-antenna panel.

14. The communication apparatus according to claim 9, wherein:
the main antenna panel is connected to the auxiliary antenna panel through a telescopic component; and
the processing unit is further configured to:
adjust a telescopic length of the auxiliary antenna panel relative to the main antenna panel.

15. The communication apparatus according to claim 14, wherein the auxiliary antenna panel comprises a first sub-antenna panel and a second sub-antenna panel, the first sub-antenna panel is connected to the main antenna panel through a first telescopic component, and the second sub-antenna panel is connected to the first sub-antenna panel through a second telescopic component.

16. A non-transitory computer-readable storage medium, having stored thereon processor-executable instructions that, when executed by one or more processors, are configured to cause the one or more processors to:
obtain wind speed information;
determine, based on the wind speed information, whether to adjust a configuration of an auxiliary antenna panel, wherein the configuration of the auxiliary antenna panel comprises one of a deployed configuration and a stowed configuration, an antenna panel is in the deployed configuration for the antenna panel performing signal transmission, and the antenna panel comprises a main antenna panel in a deployed configuration and the auxiliary antenna panel; and
adjust the configuration of the auxiliary antenna panel in response to determining to adjust the configuration of the auxiliary antenna panel.

17. The non-transitory computer-readable storage medium according to claim 16, wherein the processor-executable instructions, when executed by the one or more processors, are further configured to cause the one or more processors to:
obtaining service information; and
determine, based on the wind speed information and the service information, whether to adjust the configuration of the auxiliary antenna panel.

18. The non-transitory computer-readable storage medium according to claim 16, wherein the processor-executable instructions, when executed by the one or more processors, are further configured to cause the one or more processors to adjust an angle between the auxiliary antenna panel and the main antenna panel, wherein the main antenna panel is movably connected to the auxiliary antenna panel.

19. The non-transitory computer-readable storage medium according to claim 18, wherein the auxiliary antenna panel is connected to the main antenna panel through a component that supports 360-degree free movement.

20. The non-transitory computer-readable storage medium according to claim 16, wherein the processor-executable instructions, when executed by the one or more processors, are further configured to cause the one or more processors to adjust a telescopic length of the auxiliary antenna panel relative to the main antenna panel, wherein the main antenna panel is connected to the auxiliary antenna panel through a telescopic component.
